(19) United States
(12) Patent Application Publication
(10) Pub. No.: US 2015/0286092 A1
(43) Pub. Date: Oct. 8, 2015

(54) LIQUID CRYSTAL DISPLAY DEVICE

(71) Applicant: SHARP KABUSHIKI KAISHA, Osaka (JP)

(72) Inventor: Kohki Ejiri, Osaka-shi (JP)

(73) Assignee: SHARP KABUSHIKI KAISHA, Osaka-shi, Osaka (JP)

(21) Appl. No.: 14/437,948

(22) PCT Filed: Oct. 31, 2013
(86) PCT No.: PCT/JP2013/079499

§ 371 Date: Apr. 23, 2015

(30) Foreign Application Priority Data
Nov. 9, 2012 (JP) 2012-246949

(51) Int. Cl. G02F 1/1335

(52) U.S. Cl. CPC G02F 1/133608; G02F 1/133606; G02F 1/133524

(57) ABSTRACT

Deformation due to stress is suppressed in the present invention by improving the strength of a backlight chassis without impairing inter-substrate wireability. A liquid crystal display device has an LED substrate (14a) arranged with an LED light source and a connector (141) provided on the LED substrate (14a). A backlight chassis (9) has a notch (91) for facilitating establishing a wired connection with the connector (141) and an embankment-form convex portion (92) in the vicinity of the chassis (91).

### TECHNICAL FIELD

The present invention relates to a liquid crystal display device, and more specifically relates to a liquid crystal display device having a structure of supplying electric power to a backlight light source to illuminate a liquid crystal panel.

### BACKGROUND OF THE INVENTION

These days, a screen size of a liquid crystal display device such as a thin type television is becoming larger, and products having a screen size of, for example, a 60-inch type, a 70-inch type and an 80-inch type are sold. In such a liquid crystal display device, one which uses an LED (Light Emitting Diode) as a backlight light source instead of a conventional fluorescent tube is most commonly used. Moreover, the liquid crystal display device is used not only for a television but in various applications such as a monitor of a PC (personal computer) and a digital signage (electronic sign), and the LED is also required to have higher luminance (higher output power) accordingly.

A system configuration of a backlight includes an edge-light type backlight in which a light source is provided in an edge portion of a light guide plate and a direct-type backlight type in which the light source is provided directly under a display screen. In the edge-light type backlight, since the light source is not arranged directly under a liquid crystal panel, it is possible to reduce thickness of the liquid crystal display device compared to the direct-type one, and it is advantageous in promoting thickness reduction. Moreover, not only a so-called double-edge type backlight in which light sources are arranged on both upper and lower sides or both right and left sides of the liquid crystal panel but also a so-called single-edge type backlight in which a light source is arranged in either one of upper or lower side or one of right or left side of the liquid crystal panel are used in many cases.

The light source of the backlight is configured, for example, by arranging a plurality of LEDs (Light Emitting Diodes) linearly and is arranged on an LED substrate. Then, in the edge-light type backlight, a light emission portion of the LED is arranged so as to face aside end surface of the light guide plate. The LED is used as the backlight light source in many cases because of generally having high color purity, having excellent dimming stability and high-speed response, etc. Further, as the LED, a white LED which emits white light with one LED, and an LED which emits each monochromatic light of RGB are used. By using the LED for monochromatic light emission of RGB, wide color gamut performance is achieved. In addition, the white LED is low in cost and has advantages of enabling suppression of overall power consumption because of a relation of the required number of LEDs, etc.

Light emitted from each LED enters into an inside of the light guide plate from a side end surface which is an incidence surface of the light guide plate, and is guided while being diffused inside the light guide plate, and emitted from an emission surface on a front face side (liquid crystal panel side). A reflection sheet is disposed on a back face side of the light guide plate (opposite side to the liquid crystal panel), and reflects light leaked from a surface on the back face side of the light guide plate to return to the front face side for enhancing usage efficiency of the light. A backlight chassis of a plate-shaped member as a member which holds component members of the backlight integrally is provided on the back face side of the light guide plate.

A light source system using an LED includes the LED, an LED substrate (light source substrate) which is a substrate on which the LED is mounted, an LED driver substrate (light source driving substrate) which produces electric power and a signal for driving and controlling the LED, and a wire for performing connection between the respective substrates. A connector for connecting the wire with the LED driver substrate is provided in the LED substrate.

In a conventional configuration example, the LED driver substrate for driving and controlling the LED is provided on a back face side of the backlight chassis for the purpose of avoiding deterioration in in-plane uniformity of illumination resulting from existence of the LED driver substrate, and reducing thickness of a backlight unit for seeking frame-narrowing, etc. Then, the wire is connected from the LED driver substrate provided on the back face side of the backlight chassis with the connector of the LED substrate on which the LED is mounted, which is provided in a vicinity of the light guide plate on a front face side of the backlight chassis.

As to a structure for wiring with an LED substrate, for example, Patent Literature 1 discloses an LED backlight aiming that deterioration in in-plane uniformity of brightness is prevented for enabling reduction in thickness and frame-narrowing, and a wire length is reduced as well as wiring is carried out easily. In this LED backlight, an LED is provided on one surface of the LED substrate, and this LED substrate is mounted on a chassis panel such that a surface facing the one surface of the LED substrate contacts the chassis panel. Then, a connection hole which passes through the chassis panel is provided in a part of a region of the chassis panel on which the LED substrate is mounted. This makes is possible to improve workability of wiring of the LED substrate provided on the one surface side of the chassis panel with an LED driver substrate provided on a surface in an opposite side to the chassis panel.

### PRIOR ART DOCUMENT

### Patent Document

Patent Document 1: WO 2008-108039

### SUMMARY OF THE INVENTION

### Problem to be Solved by the Invention

As described above, in a step for assembling a display by arranging members such as the light guide plate, the liquid crystal panel and other optical sheets on the front face side of the backlight chassis, in order to connect the wire of the LED driver substrate with the connector of the LED substrate, an operator needs to perform operation for connecting the wire with the connector which is included in the LED substrate provided in a vicinity of the light guide plate inside the backlight chassis from the back face side of the backlight chassis in which the LED driver substrate is provided.

In order to perform such connection operation, an opening is provided in advance in a part of the backlight chassis to allow the operator to perform the wire connection with the connector of the LED substrate by inserting his/her hand in the opening from the back face side of the backlight chassis. For example, a notch is provided as the above-described opening in a region in a vicinity of the LED substrate of the backlight chassis, and using this notch makes it possible to perform the wiring operation with the connector of the LED substrate.

FIG. 8 is a view explaining a configuration example of a notch provided in a backlight chassis, in which FIG. 8(A) is a view showing an enlarged main part of a backlight chassis 9 in back view and FIG. 8(B) is a schematic perspective view of a cross section thereof. Each figure shows members around the backlight chassis with partial omission.

In this example, an LED substrate 14 is arranged further outside an end edge of the backlight chassis 9, and a not-shown LED is mounted on the LED substrate 14. The LED is provided so as to face a side end surface of a light guide plate 12 which is positioned on a front face side of the backlight chassis 9.

The LED substrate 14 is provided with a connector 141 for wiring a harness cable 101 from a not-shown LED driver substrate. Further, the backlight chassis 9 is provided with a notch 91 in a vicinity of a position of the connector 141. By providing the notch 91, it is possible to impart workability for connecting the harness cable 101 with the connector 141 of the LED substrate 14 in a step of assembling a liquid crystal display device. An operator is able to perform operation of connecting the harness cable 101 with the connector 141 by using a space of this notch 91.

However, since the backlight chassis 9 is produced by using a plate-shaped member made of metal, for example, such as iron, when being provided with the opening such as the notch 91, it has deteriorated rigidity of that part and is easily deformed with stress from outside concentrated. In particular, when the notch 91 such that a hand of the operator is allowed to enter in is provided in the backlight chassis, it becomes necessary to secure an area of the notch to an extent that wiring operation is able to be performed, which easily causes deformation due to the stress as described above. Furthermore, when the backlight chassis 9 is deformed, reliability and stability of optical members, electric and electronic members and the like which are held inside are possibly impaired and a design as a product is possibly not able to be maintained. Moreover, in this case, there is also a problem that, as shown with E of FIG. 8(B), when the harness cable 101 is in contact with an edge of the notch 91, the harness cable 101 is possibly scratched and broken.

Though the LED backlight of Patent Literature 1 is provided with the connection hole in the chassis panel (corresponding to the backlight chassis) for connecting the LED substrate and the LED driver substrate, even in the case of the connection hole, it may be said that opening thereof makes rigidity of that part deteriorated and deformation due to concentration of the stress easily occurs.

The present invention has been made in view of circumstances as described above, and aims to provide a liquid crystal display device capable of, in a configuration where a substrate on which a light source of a backlight is mounted and a light source driving substrate mounted on a backlight chassis are wired, suppressing deformation due to stress by improving strength of the backlight chassis without impairing workability for wiring between the substrates.

### Means for Solving the Problem

To solve the above problems, a first technical means of the present invention is a liquid crystal display device, comprising a light source, a light guide plate that diffuses light from the light source inside thereof for emission, a back-face chassis of a plate-shaped member that holds the light guide plate, and a liquid crystal panel that is illuminated by the light emitted from the light guide plate, wherein a light source substrate arranged with the light source and a connector provided in the light source substrate are included, and the back-face chassis has a notch for imparting workability for connecting a wire with the connector and has an embankment-shaped convex portion in a vicinity of the notch.

A second technical means is the liquid crystal display device of the first technical means, wherein the embankment-shaped convex portion is along the notch.

A third technical means is the liquid crystal display device of the first or the second technical means, wherein the convex portion is projected to a side of a harness cable connected with the connector.

A fourth technical means is the liquid crystal display device of any one of the first to the third technical means, wherein the convex portion is formed by applying draw processing to the back-face chassis.

### Effect of the Invention

According to the present invention, it is possible to provide a liquid crystal display device capable of, in a configuration where a substrate on which a light source of a backlight is mounted and a light source driving substrate mounted on a backlight chassis are wired, suppressing deformation due to stress by improving strength of the backlight chassis without impairing workability for wiring between the substrates.

### BRIEF DESCRIPTION OF DRAWINGS

FIG. 1 is a view showing one example of an appearance of a liquid crystal display device according to the present invention.

FIG. 2 is a view showing a state where a back-face cabinet is detached from the liquid crystal display device shown in FIG. 1.

FIG. 3 is a view showing one example of a state of an exploded internal structure of the liquid crystal display device shown in FIG. 1.

FIG. 4 is a view showing a cross section of an upper end part of the liquid crystal display device shown in FIG. 1.

FIG. 5 is an overall view of a backlight chassis included in the liquid crystal display device.

FIG. 6 is a view explaining a configuration example of a notch provided in the backlight chassis and a surrounding structure thereof.

FIG. 7 is a view explaining another configuration example of the notch provided in the backlight chassis and the surrounding structure thereof.

FIG. 8 is a view explaining a configuration example of a notch provided in a backlight chassis in a conventional liquid crystal display device.

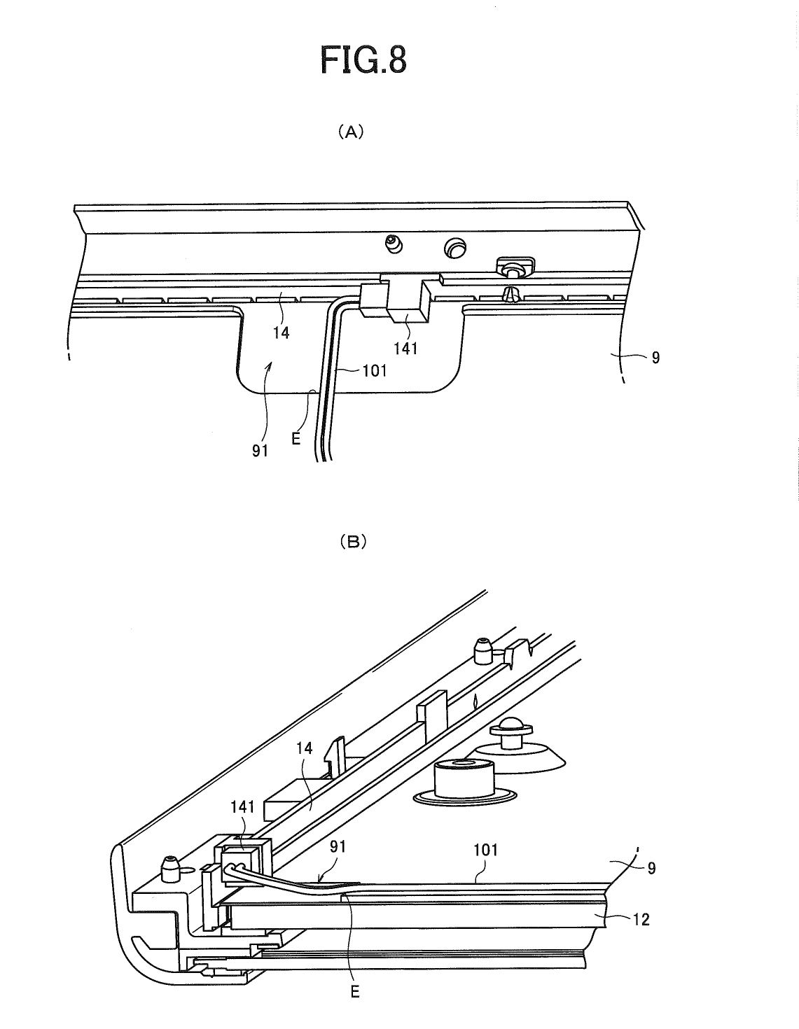

### PREFERRED EMBODIMENT OF THE INVENTION

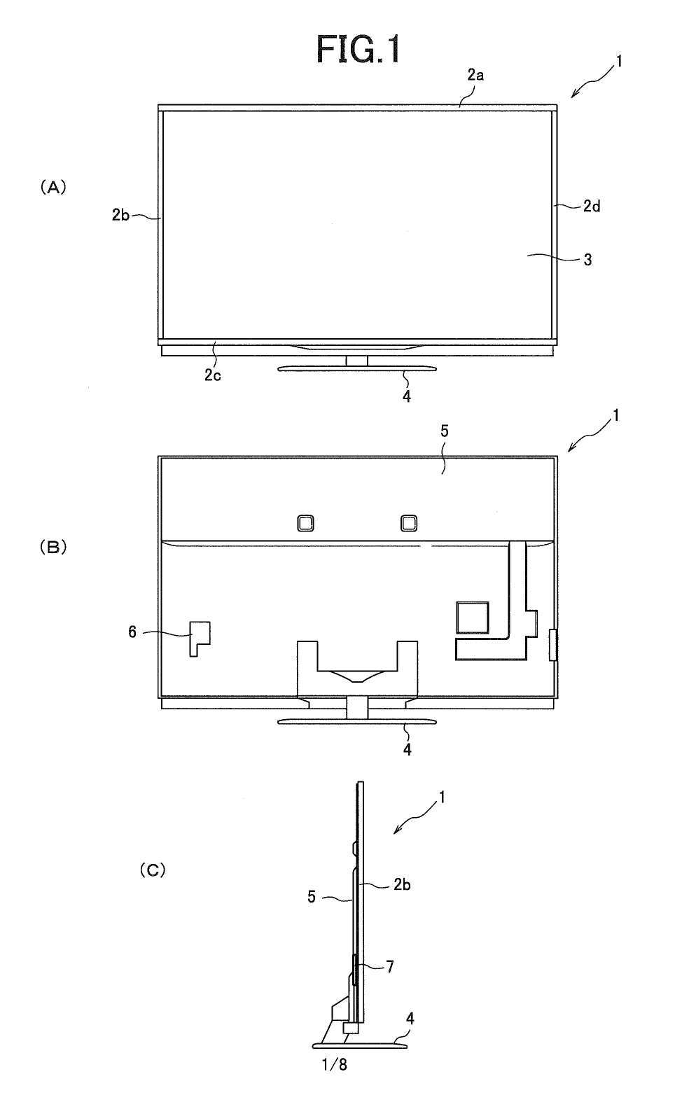

FIG. 1 is a view showing one example of an appearance of a liquid crystal display device according to the present invention. FIG. 1(A) shows a state of the liquid crystal display device in front view, FIG. 1(B) shows a state of the liquid crystal display device in back view, and FIG. 1(C) shows a state of the liquid crystal display device in left view. In the figures, 1 denotes the liquid crystal display device, 2a to 2d denote front-face frames (front-face cabinets), 3 denotes a liquid crystal panel, 4 denotes a stand (support pedestal), 5 denotes a back-face cabinet, 6 denotes a power cord pulling out portion, and 7 denotes an operation button portion.

In FIG. 1, the liquid crystal panel 3 has a configuration in which a liquid crystal is sandwiched between two glass substrates, and has a function as a light shutter that controls transmittance/block of light emitted from (not shown in FIG. 1) when an alignment state of liquid crystal molecules constituting the liquid crystal is controlled. Moreover, the front-face frames 2a to 2d are provided so as to surround the liquid crystal panel 3 and have a frame structure in which the front-face cabinet is vertically and horizontally divided into four. The front-face frames 2a to 2d are made of not a resin but metal, for example, such as aluminum alloy for enhancing designability.

In the resin-made back-face cabinet 5, the stand 4 that supports the liquid crystal display device 1 is attached and the power cord pulling out portion 6 for pulling out a power cord from an inside of the liquid crystal display device 1 is formed. Moreover, the operation button portion 7 for operating the liquid crystal display device 1 is provided on a left-side face of the liquid crystal display device 1.

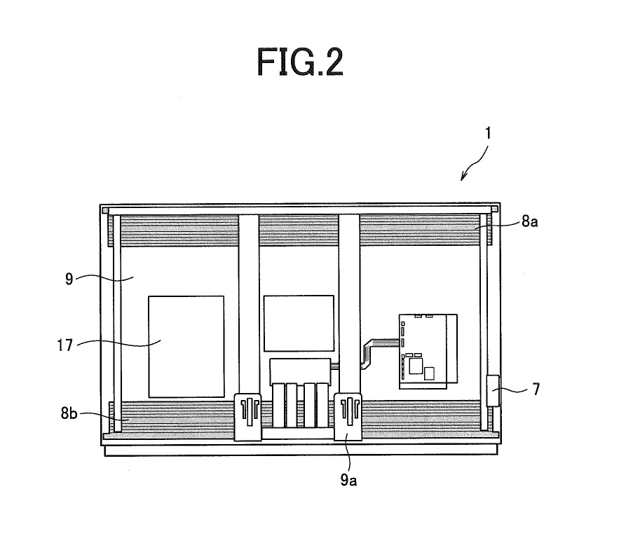

FIG. 2 is a view showing a state where the back-face cabinet 5 is detached from the liquid crystal display device 1 shown in FIG. 1. In the state where the back-face cabinet 5 is detached, a back-face chassis (hereinafter referred to as backlight chassis) 9, and heat spreaders 8a and 8b are seen. The heat spreaders 8a and 8b function as heat dissipation members for dissipating heat generated from an LED light source, and are made of, for example, aluminum alloy having high heat dissipation performance. Further, the backlight chassis 9 is formed by processing a plate-shaped member made of metal, for example, such as iron, and the heat spreaders 8a and 8b are fixed to upper and lower ends of a back face of the backlight chassis 9. A center seal and auxiliary metal fitting framework 9a is fixed to a back face side of the backlight chassis 9 and the heat spreaders 8a and 8b.

A power supply substrate 17 is provided on a front surface in the back face side of the backlight chassis 9 and is connected with the power cord. The power supply substrate 17 has a function as a light source driving substrate for driving and controlling an LED light source. An LED substrate (not shown in FIG. 2) on which an LED is mounted and the power supply substrate 17 are connected by a harness cable (not shown in FIG. 2) and driving electric power is supplied to the LED.

A vertical length of the heat spreaders 8a and 8b is about 150 mm, for example, when a screen size is 70 inches and material of the heat spreaders 8a and 8b is aluminum. This length is able to be determined appropriately by calculating an area needed for heat dissipation with respect to a heat generation amount of the LED according to the screen size. Further, since the heat spreaders 8a and 8b are arranged on the back face of the backlight chassis 9, it is possible to increase the heat dissipation area and to obtain high heat dissipation effect.

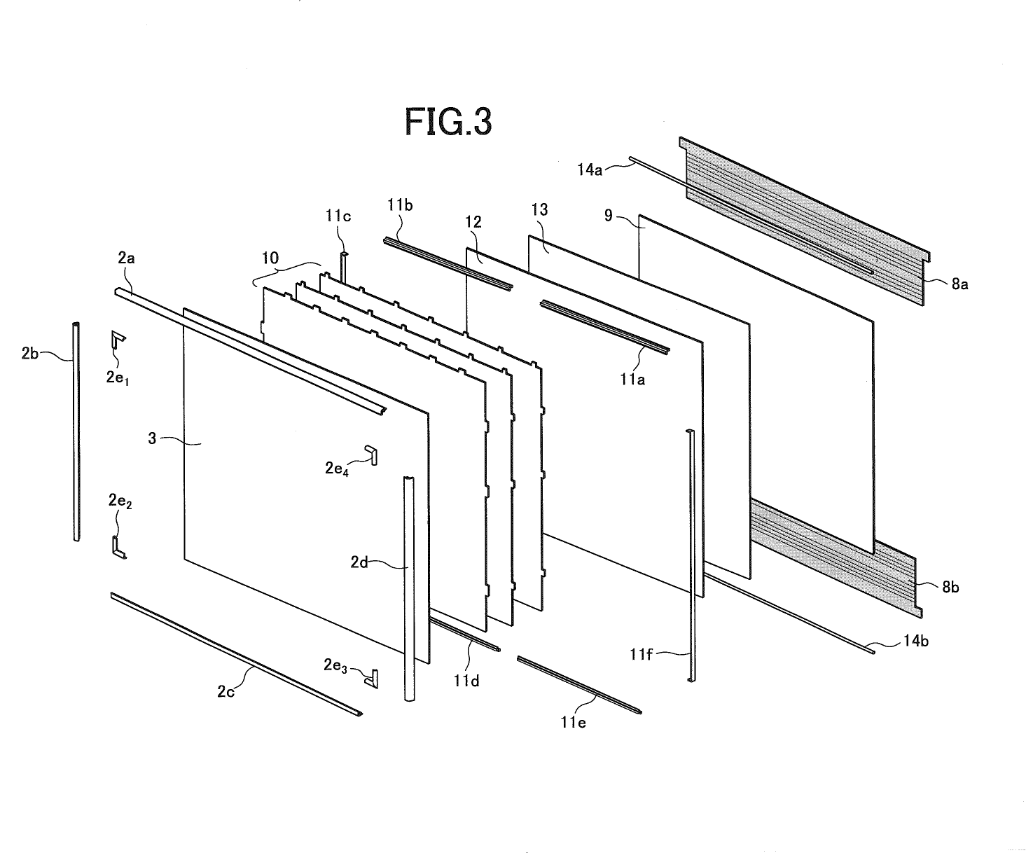

FIG. 3 is a view showing one example of a state of an exploded internal structure of the liquid crystal display device 1 shown in FIG. 1. The liquid crystal display device 1 is provided with the metallic front-face frames 2a to 2d as the front-face cabinets. These four front-face frames 2a to 2d are assembled as one frame member with four frame fastening metal fittings 2e₁ to 2e₄ and fixed around the liquid crystal panel 3.

On a back face side of the liquid crystal panel 3, an optical sheet 10, a light guide plate 12, and a reflection sheet 13 are provided in this order. The optical sheet 10 is composed of, for example, two micro lens sheets and one luminance improved sheet, and has functions of improving luminance in a front side direction of light emitted from the light guide plate 12, etc.

The light guide plate 12 is formed by an acrylic resin, a polycarbonate resin, a cycloolefin-based resin (COP) or the like, and diffuses light which is incident from a backlight light source inside thereof and emits it toward the liquid crystal panel 3. The reflection sheet 13 is disposed on a back face side of the light guide plate 12 and reflects light which is leaked from a surface on the back face side of the light guide plate 12 to return frontward for enhancing usage efficiency of light.

The backlight chassis 9 is provided on the back face side of the light guide plate 12 and the reflection sheet 13 and holds the light guide plate 12 and the reflection sheet 13. The heat spreaders 8a and 8b are provided outside the backlight chassis 9, holds LED substrates 14a and 14b having an LED light source arranged therein at a position facing incidence surfaces which are formed on upper and lower ends of the light guide plate 12, and dissipates heat generated from the LED substrates 14a and 14b.

Moreover, the liquid crystal display device 1 includes intermediate chassis 11a to 11f formed by material such as a resin and rubber. The intermediate chassis 11a to 11f themselves also have insulating characteristics. In this example, the intermediate chassis is divided into six, but may be divided into, for example, four, and the number of the division is not limited. These intermediate chassis 11a to 11f are inserted between a peripheral part of the optical sheet 10 and a peripheral part of the light guide plate 12.

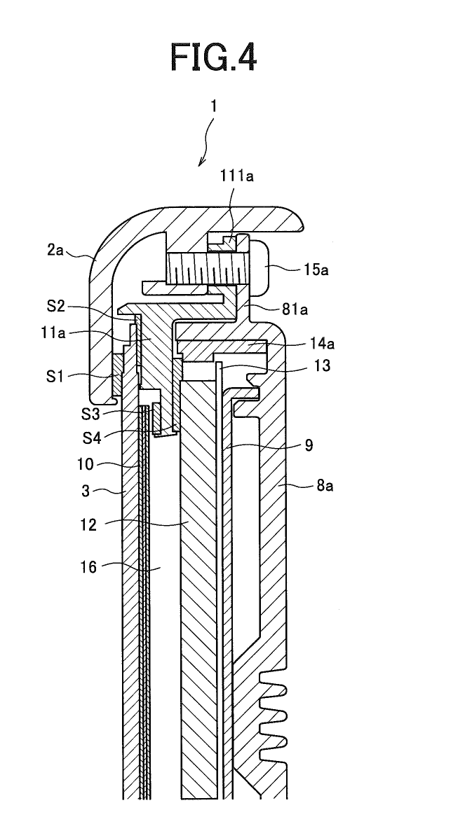

FIG. 4 is a view showing a cross section of an upper end part of the liquid crystal display device 1 shown in FIG. 1. In the liquid crystal display device 1 (upper part side), as described above, the front-face frame 2a, the liquid crystal panel 3, the optical sheet 10, the intermediate chassis 11a, the light guide plate 12, the reflection sheet 13, the backlight chassis 9, the heat spreader 8a and the LED substrate 14a are provided.

The heat spreader 8a to which the LED substrate 14a is fixed is curved toward an inner side of a vertical direction at an end part on a back face side of the LED substrate 14a and stretched by a predetermined length. The heat spreader 8a dissipates heat generated at the LED substrate 14a in which the LED serving as a heat source is arranged effectively. The backlight chassis 9 is fixed to the heat spreader 8a on a front side of the heat spreader 8a (liquid crystal panel 3 side). Heat transferred to the heat spreader 8a is transferred also to the backlight chassis 9 and dissipated also from the backlight chassis 9. The intermediate chassis 11a is provided to extend between the front-face frame 2a and the heat spreader 8a, and has a part inserted between the peripheral part of the optical sheet 10 and the peripheral part of the light guide plate 12.

The front-face frame 2a and a flange 81a formed in the heat spreader 8a are integrally fixed by a fixing member such as a screw 15a from a back face side with a flange 111a which is provided to extend from the intermediate chassis 11a held. Note that, as to the fixed location, for example, four corners of the liquid crystal display device 1 are fixed. By performing fixing with the screw from the back face toward the front face in this manner, it is possible to secure strength of a housing, and it is further possible to hide the screw, so that it is desirable from a viewpoint of designability.

With this configuration, the heat spreader 8a, the intermediate chassis 11a and the front-face frame 2a are fixed integrally, and the reflection sheet 13, the light guide plate 12, the optical sheet 10 and the liquid crystal panel 3 are held being overlapped in turn from the backlight chassis 9 side between the backlight chassis 9 fixed to the heat spreader 8a and the front-face frame 2a. At this time, by arranging the intermediate chassis 11a between the heat spreader 8a and the front-face frame 2a and inserting a part of the intermediate chassis 11a between the peripheral part of the optical sheet 10 and the peripheral part of the light guide plate 12, an air layer 16 is formed at a predetermined interval between the optical sheet 10 and the light guide plate 12. The interval of this air layer 16 is, for example, about 3 mm. Note that, the optical sheet 10 is fixed in a form that a plurality of holes (not shown) formed along a peripheral edge of the optical sheet 10 are engaged with ribs (not shown) formed in the intermediate chassis 11a to 11f.

The LED substrate 14a is provided in a vicinity of the light guide plate 12 so that the LED faces a side end surface of the light guide plate 12. On the back face side of the backlight chassis 9 (right side in FIG. 4), the power supply substrate 17 as shown in FIG. 2 is provided, and the power supply substrate 17 and the LED substrate 14a are connected by a not-shown harness cable.

Moreover, a lower end side of the liquid crystal display device has the similar configuration, and the LED substrate 14b which is arranged in a lower side is connected with the power supply substrate 17 with the harness cable.

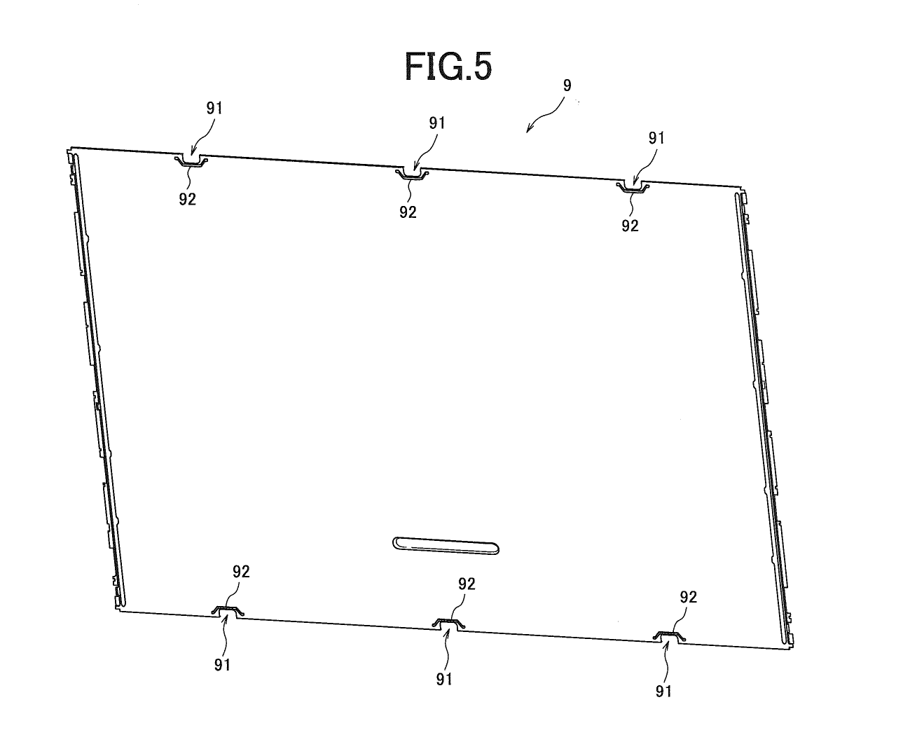

FIG. 5 is an overall view of a backlight chassis included in the liquid crystal display device with the above-described configuration. The backlight chassis 9 is provided on the back face side of the light guide plate 12 and the reflection sheet 13 as described above, and is provided with a plurality of notches 91 for maintaining workability of the harness cable for the LED substrates 14a and 14b. In this example, the LED substrates 14a and 14b are provided on both upper and lower sides of the backlight chassis 19 and connectors of the LED substrates 14a and 14b are provided at three places on each of the upper and lower sides.

The notches 91 of the backlight chassis 19 are provided correspondingly to positions of these connectors and impart workability for connecting the harness cable with the connectors. That is, the operation of connecting the harness cable connected to the not-shown power supply substrate which is provided on the back face side of the backlight chassis 19 (front side in the figure) with the connectors of the LED substrate 14a positioned in a vicinity of each of the notches 91 is allowed. In an embodiment according to the present invention, the backlight chassis 9 is provided with an embankment-shaped convex portion 92 along the notch 91 in a vicinity of each of the notches 91. Thereby, rigidity around the notch 91 is improved and deformation due to stress of the backlight chassis 9 is suppressed.

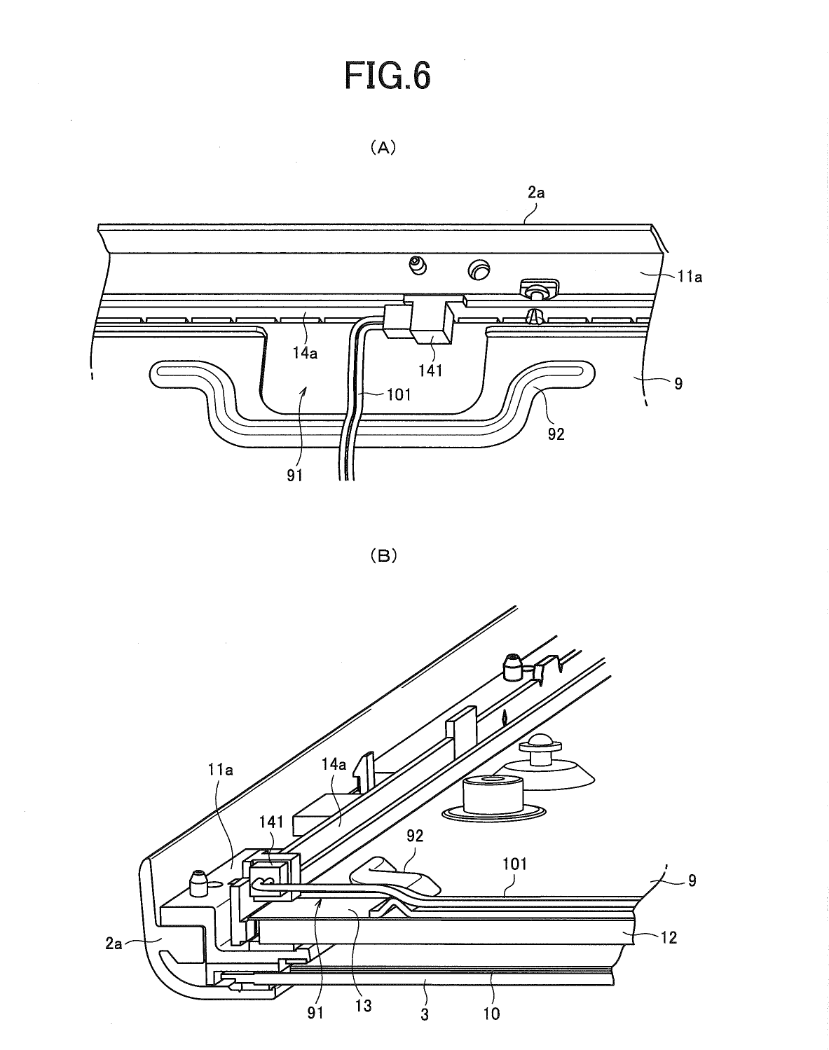

FIG. 6 is a view explaining a configuration example of the notch provided in the backlight chassis and a surrounding structure thereof, in which FIG. 6(A) is a view of an upper end part of the backlight chassis 9 in back view and FIG. 6(B) is a schematic perspective view of a cross section thereof. Each figure is shown with partial members including the heat spreader around the backlight chassis 9 omitted.

The LED substrate 14a is arranged further outside an end edge of the backlight chassis 9, and a not-shown LED is mounted on the LED substrate 14a. The LED is provided so as to face a side end surface of the light guide plate 12 which is positioned on the front face side of the backlight chassis 9. The LED substrate 14a is fixed to the heat spreader which is omitted in FIG. 6, and the intermediate chassis 11a and the front-face frame 2a are arranged further outside thereof.

The LED substrate 14a is provided with a connector 141 for wiring a harness cable 101 from the not-shown power supply substrate. Further, the backlight chassis 9 is provided with the notch 91 in a vicinity of a position of the connector 141. By providing the notch 91, it is possible to impart workability for connecting the harness cable 101 with the connector 141 of the LED substrate 14 in a step of assembling the liquid crystal display device.

Furthermore, in a vicinity of the notch 91, the embankment-shaped convex portion 92 is provided along the notch 91 so as to surround the notch 91. The convex portion 92 is able to be formed by applying draw processing to the backlight chassis 9 made of, for example, a metallic plate-shaped member, and is able to be formed as a structure having a ridge which is convexed from a front surface of the backlight chassis 9 and a groove-shaped concave portion on a rear side thereof. By providing this embankment-shaped convex portion 92, it is possible to improve rigidity around the notch 91 and suppress deformation due to stress of the backlight chassis 9.

Moreover, the convex portion 92 is formed so as to be projected to a side of the harness cable 101 connected to the connector 141. The side of the harness cable 101 serves as the back face side of the backlight chassis 9. Thereby, when the harness cable 101 connected to the not-shown power supply substrate is connected with the connector 141 of the LED substrate 14a, the harness cable 101 is wired in a state of being in contact with a top part of the convex portion 92. By causing the harness cable 101 to be in contact with the top part of the convex portion 92, it is possible to cause the harness cable 101 not to be in contact with an edge of the notch 91, thus making it possible to prevent the harness cable 101 from being broken and damaged. In particular, by causing a front surface of the top part of the convex portion 92 not to have a sharp shape, the harness cable 101 is able to be protected against damage.

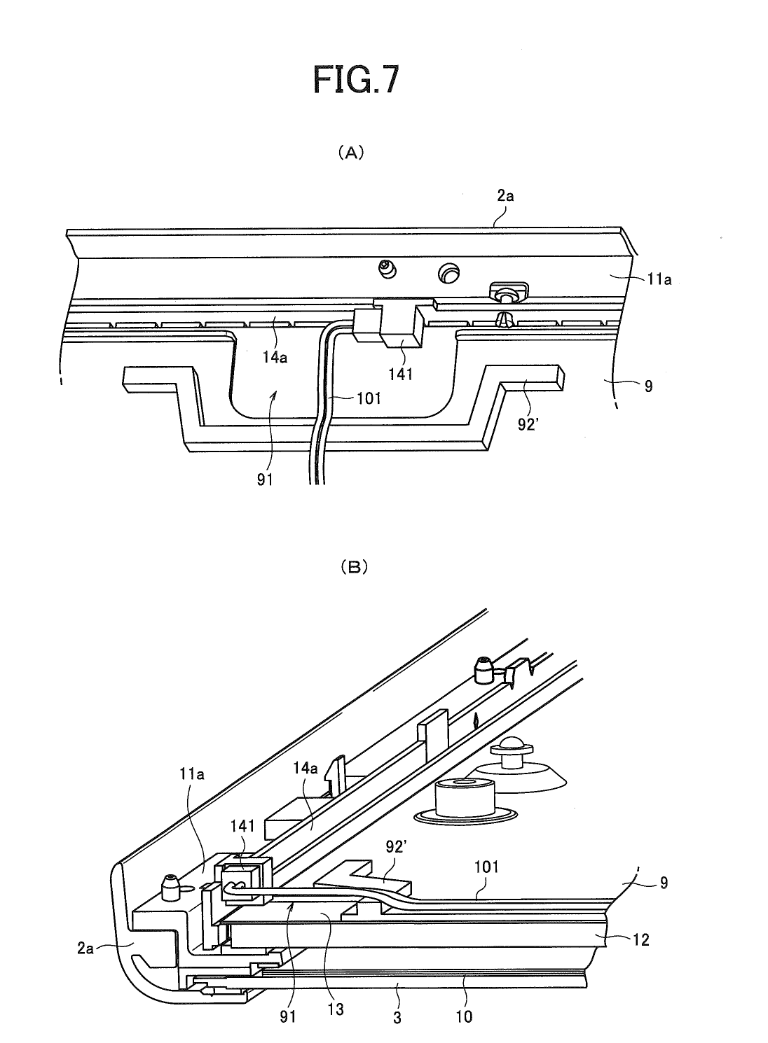

FIG. 7 is a view explaining another configuration example of the notch provided in the backlight chassis and the surrounding structure thereof, in which FIG. 7(A) is a view of the upper end part of the backlight chassis 9 in back view and FIG. 7(B) is a schematic perspective view of a cross section thereof. In this configuration example, similarly to the configuration of FIG. 6, though an embankment-shaped convex portion 92′ is provided along the notch 91 in a vicinity of each of the notches 91 of the backlight chassis 9, the convex portion 92′ is formed by adhering a separate member or a separate material to the plate-shaped backlight chassis 9 in the case of this configuration example.

In this configuration example, the embankment-shaped convex portion 92′ is provided along the notch 91 so as to surround the notch 91 in a vicinity of the notch 91. The convex portion 92′ is formed by attaching, to the backlight chassis 9 made of a metallic plate-shaped member, a prismatic part serving as the separate member, for example. The part for forming the convex portion 92′ may be configured by one member having a shape along the notch 91 or may be configured by a plurality of divided members. Moreover, in the example of FIG. 7, the convex portion 92′ is configured by the prismatic part, but the shape of the part is not limited to the prismatic shape. For example, it may have a columnar shape with a semicircular cross section.

The part as the separate member for forming the convex portion 92′ is formed by, for example, a metallic material or a resin material, and this part is able to be adhered to the backlight chassis 9 by using an adhesive agent or a viscous adhesive agent. Alternatively, the part formed by the metallic material may be integrated with the backlight chassis 9 by welding. Alternatively, the part formed by a metallic material or a resin material may be fixed to the backlight chassis 9 by using a fixing member such as a screw. Further, the material of the part as the separate member is not limited to the above-described metallic material or the resin material, and a ceramic material, a composite material of metal and resin, and the like may be applied appropriately.

Alternatively, the shape of the convex portion 92′ may be formed not by one for adhering the part as the separate member but by thermally spraying a thermal spraying material such as metal, ceramic and resin materials to the backlight chassis 9 for bulging up.

By providing the above-described embankment-shaped convex portion 92′, it is possible to improve rigidity around the notch 91 and suppress deformation due to the stress of the backlight chassis 9.

Moreover, the convex portion 92′ is formed so as to be projected to the side of the harness cable 101 connected to the connector 141, and the harness cable 101 is made in contact with the top part of the convex portion 92′, so that it is possible to cause the harness cable 101 not to be in contact with the edge of the notch 91, thus making it possible to prevent the harness cable 101 from being broken and damaged.

Since other configuration shown in FIG. 7 is the same as the configuration of FIG. 6, repetitive description thereof will be omitted.

The liquid crystal display device may be a liquid crystal display device comprising a light source, a light guide plate that diffuses light from the light source inside thereof for emission, a back-face chassis of a plate-shaped member that holds the light guide plate, and a liquid crystal panel that is illuminated by the light emitted from the light guide plate, in which a light source substrate arranged with the light source and a connector provided in the light source substrate are included, and the back-face chassis has a notch for imparting workability for connecting a wire with the connector and has an embankment-shaped convex portion in a vicinity of the notch.

Moreover, the liquid crystal display device may have the embankment-shaped convex portion along the notch. This makes it possible to provide a liquid crystal display device capable of, in a configuration where the light source substrate on which the light source of a backlight is mounted and a light source driving substrate mounted on the back-face chassis (backlight chassis) are wired, suppressing deformation due to stress by improving strength of the back-face chassis without impairing workability for wiring between the substrates.

Moreover, the liquid crystal display device may have the convex portion projected to a side of a harness cable connected with the connector. This makes it possible to cause the harness cable not to be in contact with an edge of the notch, thus making it possible to prevent the harness cable from being broken and damaged.

Moreover, the liquid crystal display device may be formed by applying draw processing to the back-face chassis.

### EXPLANATIONS OF LETTERS OR NUMERALS

1 . . . liquid crystal display device, 2a . . . front-face frame, 3 . . . liquid crystal panel, 4 . . . stand, 5 . . . back-face cabinet, 6 . . . power cord pulling out portion, 7 . . . operation button portion, 8a, 8b . . . heat spreader, 9 . . . backlight chassis, 10 . . . optical sheet, 11a . . . intermediate chassis, 12 . . . light guide plate, 13 . . . reflection sheet, 14 . . . LED substrate, 14a, 14b . . . LED substrate, 15a . . . screw, 16 . . . air layer, 17 . . . power supply substrate, 19 . . . backlight chassis, 91 . . . notch, 92, 92′ . . . convex portion, 9a . . . auxiliary metal fitting framework, 81a . . . flange, 101 . . . harness cable, 111a . . . flange, and 141 . . . connector.

1. A liquid crystal display device, comprising a light source, a light guide plate that diffuses light from the light source inside thereof for emission, a back-face chassis of a plate-shaped member that holds the light guide plate, and a liquid crystal panel that is illuminated by the light emitted from the light guide plate, wherein
a light source substrate arranged with the light source and a connector provided in the light source substrate are included, and
the back-face chassis has a notch and an embankment-shaped convex portion in a vicinity of the notch.

2. The liquid crystal display device according to claim 1, wherein
the embankment-shaped convex portion is along the notch.

3. The liquid crystal display device according to claim 1, wherein
the convex portion is projected to a side of a harness cable connected with the connector.

4. The liquid crystal display device according to claim 1, wherein
the convex portion is formed by applying draw processing to the back-face chassis.
